(19) United States
(12) Patent Application Publication
(10) Pub. No.: US 2005/0148467 A1
(43) Pub. Date: Jul. 7, 2005

(54) Heat-sensitive recording material

(76) Inventors: Jouko Makitalo, Eura (FI); Elina Mattila, Koylio (FI); Aria Pylvas, Huittinen (FI)

Correspondence Address: NIXON & VANDERHYE, PC, 1100 N GLEBE ROAD, 8TH FLOOR, ARLINGTON, VA, 22201-4714, US

(21) Appl. No.: 10/492,020

(22) PCT Filed: Oct. 11, 2002
(86) PCT No.: PCT/FI02/00797

(30) Foreign Application Priority Data
Oct. 12, 2001 (FI) 20011984

(51) Int. Cl. B41M 5/24

(52) U.S. Cl. 503/204

(57) ABSTRACT

The present invention relates to a heat-sensitive recording material comprising a base layer and at least one coating layer, the coating layer containing the chemicals required by at least two color forming systems whereby one color forming system used is a chelate-type color forming system and the other one a compound of at least one leuco dye and at least one urea-based developer.

The present invention relates to a heat-sensitive recording material. In particular the invention relates to a heat-sensitive recording material having an improved duration of readable print image.

Heat-sensitive material is typically paper, plastics or corresponding web-type material composed of several layers and used typically in sheet or roll form. The main layers are at least base paper, base plastics or corresponding material, and coating. Additionally, the main layers may include pre-coating and/or surface coating either on one or both sides of the web. At least a color forming agent, a developing agent and a sensitizing agent and various pigments and corresponding substances used in most cases are situated in the coating. When heated to a suitable temperature the coating melts, in some cases softens or sublimates, thus allowing reactions of other components of the coating, whereby, as a consequence of the chemical reaction, a colored trace is produced in the recording material.

Heat-sensitive recording material is manufactured by applying with a coating machine a coating onto a suitable base paper web, plastic film, resin-coated paper or corresponding material, and in most cases subsequently drying and calendering the web. The coating used is usually manufactured by pulverizing at least one color former, at least one developer and at least one sensitizer separately into water or any suitable dissolvent in order to produce a dispersion. Generally these components of the coating are even ground to a suitable particle size in order to adjust the reaction sensitivity to the desired level. If it is desirable to use a stabilizer, it is treated the same way. The fines dispersions produced in this way are mixed according to the desired ratio and are mixed into the binders, fillers and lubricants, which are used together as coating material in the coating machine.

Patent publications EP-A-0 968 837, U.S. Pat. No. 5,256,621 and U.S. Pat. No. 6,093,678, among others, may be mentioned as examples of patent literature discussing heat-sensitive recording material.

Heat-sensitive recording materials, i.e. in most cases so-called thermal papers, are used for example in various stickers, name tags and labels; based on the bar code printed on them the products or the properties, for example the price, of the products thus marked can be recognized automatically. A separate bar code reader is used for the recognition of the bar code. A characteristic feature in the operation of a bar code reader is that light is directed from the reader to the bar code and it reflects back from the white spaces between the bars of the bar code but does not reflect, or at least reflects substantially weaker, from the bar code itself.

Other objects where thermal papers are used are for example inexpensive printers, facsimiles, cash registers, various ticket and other dispensers. It can be stated generally that thermal printers are used where the printing apparatus itself must be extremely reliable as its operation is not controlled by anyone.

The many different uses of thermal papers have the consequence on the one hand that a remarkably long readability or identifiability of the print can be required from the thermal paper (facsimile messages, cash receipts etc.) and on the other hand that the thermal printers are in many cases (e.g. ticket dispensers) situated in places where the thermal paper prints are easily subjected to various factors degrading the quality of the print. Factors of this kind are for example humidity, heat, oil and grease compounds, solvents and plasticizers. A simple example is keeping cash receipts in a plastics or leather wallet or a purse which sets very high requirements on the thermal paper print because various plasticizers are used practically in all leather and plastics products to make the product pleasant to handle. In the same way, filing facsimile prints in a conventional plastic folder sets great requirements on the chemicals used for color forming in the print. In many cases, however, the thermal paper prints should remain readable for a very long time, for example cash receipts even for years.

Briefly expressed it may be stated that on the one hand, prints produced on thermal paper should have a very clear contrast so that they can be read automatically (for example the price and other data of a product in a bar code). On the other hand, possibly even the same print should remain readable at least with bare eyes even for years, cash receipts may be mentioned as an example.

The problems mentioned above have been successfully discussed for example in the following patent publications: U.S. Pat. No. 4,849,396, U.S. Pat. No. 5,446,009, EP-A-0 526 072 and WO-A-0035679 and also in the portion describing their state of the art technology. The two publications mentioned first try to solve the problems associated with the color permanence by using a metal-chelate-type color forming system either alone or combined with conventional leuco dye and its developer. In the two publications mentioned last, the same problem has been approached by using a urea-based chemical as the developer. The publications mentioned and the publications they cite discuss a large number of different developer and other chemicals with which the color permanence of the print has been improved to some extent.

U.S. Pat. No. 4,849,396 (Jujo Paper) relates to a thermal paper in which the print image is developed by using a metal-chelate-type color forming system. The metal-chelate system was the first color forming system introduced into the market used In thermal papers. According to the publication, double salts of higher fatty acids are used as one of the components of the system; examples of these are:
iron-zinc double salt of stearic acid
iron-zinc double salt of montanic acid
iron-zinc double salt of acid wax
iron-zinc double salt of behenic acid
iron-calcium double salt of behenic acid
iron-aluminum double salt of behenic acid
iron-magnesium double salt of behenic acid
silver-calcium double salt of behenic acid
silver-aluminum double salt of behenic acid
silver-magnesium double salt of behenic acid, and
calcium-aluminum double salt of behenic acid,
which are used either alone or with other double salts.

With these double salts, polyvalent hydroxyaromatic compounds, diphenylkarbazide, diphenylkarbazone, hexamethylenetetramine, spirobenzopyran, 1-formyl-4-phenylsemicarbazide, etc. are used for color formation.

According to the publication, in addition to the chelate system described above, the leuco color formers listed below as examples, with suitable conventional developers, may be used for the color forming:
3,3-bis(p-dimethylaminophenyl)-6-dimethylaminophthalide (crystall violet lactone)
3-diethylamino-6-methyl-7-anilinofluoran
3-(N-ethyl-p-toluidino)-6-methyl-7-anilinofluoran
3-(N-ethyl-N-isoamyl)amino-6-methyl-7-anilinofluoran
3-diethylamino-6-methyl-7-(o,p-dimethylanilino)fluoran
3-pyrolidino-6-methyl-7-anilinofluoran
3-pyperidino-6-methyl-7-anilinofluoran
3-(N-cyclohexyl-N-methylamino)-6-methyl-7-anilinofluoran
3-pyperidino-6-methyl-7-anilinofluoran
3-(N-cyclohexyl-N-methylamino)-6-methyl-7-anilinofluoran
3-diethylamino-7-(m-trifluoromethylanilino)fluoran
3-dibutylamino-7-(o-chloroanilino)fluoran
3-diethylamino-6-methyl-chlorofluoran
3-diethylamino-6-methyl-fluoran
3-cyclohexylamino-6chlorofluoran
3-diethylamino-7-(o-chloroanilino)fluoran
3-diethylamino-benzo[a]-fluoran
3-(4-diethylamino-2-ethoxyphenyl)-3-(1-ethyl-2-methyl-indole-3-yl)-4-azaphthalide
3-(4-diethylamino-2-ethoxyphenyl)-3-(1-ethyl-2-methyl-indole-3-yl)-7-azaphthalide
3-(4-diethylamino-2-ethoxyphenyl)-3-(1-octyl-2-methyl-indole-3-yl)-4-azaphthalide
3-(4-N-cyclohexyl-N-methylamino-2-methoxyphenyl)-3-(1-ethyl-2-methylindole-3-yl)-4-azaphthalide
3,6,6′-tris(dimethylamino)spiro[fluorene-9,3′-phthalide], and
3,6,6′-tris(diethylamino)spiro[fluorene-9,3′-phthalide],
   which can be used either alone or in combination with several color formers.

U.S. Pat. No. 5,446,009 (Nippon Paper) relates to thermal paper in which both leuco dye and conventional organic developer and a metal-chelate-type chromogenic (color forming) system is used. According to the publication there is no particular reason to limit the type of the leuco dye though the color former used in the publication is a fluoran-type color former or a combination of several color formers of that type:
3-Diethylamino-6-methyl-7-anilinofluorane
3-(N-ethyl-p-toluidino)-6-methyl-7-anilinofluorane
3-(N-ethyl-N-isoamylamino)-6-methyl-7-anilinofluorane
3-Diethylamino-6-methyl-7-(o,p-dimethylanilino)fluorane
3-Pyrrolidino-6-methyl-7-anilinofluorane
3-Piperidino-6-methyl-7-anilinofluorane
3-(N-cyclohexyl-N-methylamino)-6-methyl-7-anilinofluorane
3-Diethylamino-7-(m-trifluoromethylanilino)fluorane
3-N-n-Dibutylamino-6-methyl-7-anilinofluorane
3-N-n-Dibutylamino-7-(o-chloroanilino)fluorane
3-(N-ethyl-N-tetrahdrofurfurylamino)-6-methyl-7-anilinofluorane
3-Dibutylamino-6-methyl-7-(o,p-dimethylanilino)fluorane
3-(N-methyl-N-propylamino)-6-methyl-7-anilinofluorane
3-diethylamino-6-chloro-7-anilinofluorane
3-Dibutylamino-7-(o-chloroanilino)fluorane
3-Diethylamino-7-(o-chloroanilino)fluorane
3-Diethylamino-6-methyl-chlorofluorane
3-Diethylamino-6-methyl-fluorane
e-Cyclohexylamino-6-chlorofluorane
3-Diethylamino-benzo[a]-fluorane
3-n-Dipentylamino-6-methyl-7-anilinofluorane
2-(4-Oxo-hexyl)-3-dimethylamino-6-methyl-7-anilinofluorane
2-(4-Oxo-hexyl)-3-diethylamino-6-methyl-7-anilinofluorane
2-(4-Oxo-hexyl)-3-dipropylamino-6-methyl-7-anilinofluorane.

The solution of the publication uses one of the following as an organic developer:
4-hydroxy-4′-isopropoxydiphenylsulfone
4-hydroxy-4′-n-propoxydiphenylsulfone
4-hydroxy-4′-n-butoxydiphenylsulfone, and
bis(4-hydroxyphenyl)acetic acid butyl ester.

Correspondingly, one of the following or a compound of some of the following is used as one part of the metal chelate system:
Iron zinc stearate
Iron zinc montanate
Acid wax iron zinc
Iron zinc behenate
Iron calcium behenate
Iron aluminum behenate
Iron magnesium behenate
Silver calcium behenate
Tin aluminum behenate
Silver magnesium behenate, and
Calcium aluminum behenate.

Various polyhybrid hydroxyaromatic compounds, in other words polyhydrid phenol derivates, were used as the other compound of the metal chelate system.

Despite the development work carried out the metal-chelate-type color forming system was not particularly popular on the market because the chelate-type color forming system has proved to produce a very poor print sensitivity—despite the relatively high amount of chemicals the density of color has been very poor. In addition to this, the chemicals the chelate system requires are very expensive with the result that the price/quality ratio of the product has not met the expectations of the customers. The only advantage of the chelate system, i.e. the irreversibility of the color reaction, has not been considered to compensate the poor price/quality ratio, particularly after the remarkably less expensive leuco dyes producing a denser print image became available on the market.

EP-A-0 526 072 (Oji Paper) relates to a thermal paper in which urea-based chemical, more specifically expressed at least one N-arylsulfonyl(thio)urea compound, is used as the leuco dye developer. Examples of these are:
N-(p-toluenesulfonyl)-N′-phenylurea,
N-(p-toluenesulfonyl)-N′-(p-methoxyphenyl)urea,
N-(p-toluenesulfonyl)-N′-(o-tolyl)urea,
N-(p-toluenesulfonyl)-N′-(m-tolyl)urea,
N-(p-toluenesulfonyl)-N′-(p-tolyl)urea,
N-(p-toluenesulfonyl)-N′-(p-n-butylphenyl)urea,
N-(p-toluenesulfonyl)-N′,N′-diphenylurea,
N-(p-toluenesulfonyl)-N′-(o-chlorophenyl)urea,
N-(p-toluenesulfonyl)-N′-(m-chlorophenyl)urea,
N-(p-toluenesulfonyl)-N′-(2,4-dichlorophenyl)urea,
N-(p-toluenesulfonyl)-N′-methyl-N′-phenylurea,
N-(p-toluenesulfonyl)-N′-benzylurea,
N-(p-toluenesulfonyl)-N′-(1-naphthyl)urea,
N-(p-toluenesulfonyl)-N′-(1-(2-methylnaphthyl))urea,
N-(benzenesulfonyl)-N′-phenylurea,
N-(p-chlorobenzenesulfonyl)-N′-phenylurea,
N-(o-toluenesulfonyl)-N′-phenylurea,
N-(p-toluenesulfonyl)-N′-methylurea,
N-(p-toluenesulfonyl)-N′-ethylurea,
N-(p-toluenesulfonyl)-N′-(2-phenoxyethyl)urea,
N,N′-bis(p-toluenesulfonyl)urea,
N-(p-toluenesulfonyl)-N′-phenylthiourea,
N-(p-toluenesulfonyl)-N′-(o-diphenyl)urea, and
N-(p-toluenesulfonyl)-N′-(p-ethoxycarbonylphenyl)urea.

According to the publication, a conventional chemical containing triphenylmetane, fluoran or diphenylmetane should be used as the leuco dye former. Examples of these are:
3-(4-diethylamino-2-ethoxyphenyl)-3-(1-ethyl-2-methylindole-3-Yl)-4-azaphthalide,
crystal violet lactone,
3-(N-ethyl-N-isopentylamino)-6-methyl-7-anilinofluoran,
3-diethylamino-6-methyl-7-anilinofluoran,
3-diethylamino-6-methyl-7-(2′,4′-dimenthylanilino)fluoran,
3-(N-ethyl-N-p-toluidino)-6-methyl-7-anilinofluoran,
3-pyrrolidino-6-methyl-7-anilinofluoran,
3-dibutylamino-6-methyl-7-anilinofluoran,
3-(N-cyclohexyl-N-methylamino)-6-methyl-7-anilinofluoran,
3-diethylamino-7-(o-chloroanilino)fluoran,
3-diethylamino-7-(m-trifluoromethylanilino)fluoran,
3-diethylamino-6-methyl-7-chlorofluoran,
3-diethylamino-6-methylfluoran,
3-cyclohexylamino-6-clorofluoran, and
3-(N-ethyl-N-hexylamino)-6-methyl-7-(p-chloroanilino)fluoran.

Further, according to the publication, it is important to use a color stabilizing chemical, from which various organic aziridin compounds and aromatic epoxy compounds are mentioned.

According to the publication, the best result is reached when an N-arylsulfonyl(thio)urea compound is used with at least one conventional developer. As conventional developers in this context are mentioned:
2,2-bis(4-hydroxyphenyl)propane (bisphenol A),
1,1-bis(4-hydroxyphenyl)-1-phenylethane,
1,4-bis(1-methyl-1-(4′-hydroxyphenyl)ethyl)benzene,
1,3-bis(1-methyl-1-(4′-hydroxyphenyl)ethyl)benzene,
dihydroxydiphenylether,
benzyl p-hydroxy-benzoate,
bisphenol S,
4hydroxy-4′-isopropyl-oxydiphenyisulfone,
1,1-di-(4-hydroxyphenyl)-cyclohexane,
1,7-di(4-hydroxyphenylthio)-3,5-dioxaheptane, and
3,3′-diallyl4,4′-dihydroxydiphenylsulfone.

WO-A-0035679 (CIBA SPECIALTY CHEMICALS) relates to thermal paper in which the developer is a urea-based chemical. Technically, the publication is very close to the EP publication discussed above; thus, only the urea compounds used as the developer need to be mentioned:
N-(p-toluenesulphonyl)-N′-(4-trimethylacetophenyl)urea)
N-(benzenesulphonyl)-N′-(3-p-toluenesulphonyloxyphenyl)urea)
N-(p-toluenesulphonyl)-N′-(2-n-butylaminosulphonylpheryl)urea)
N-(P-toluenesulphonyl)-N′-(4-trimethylacetophenyl)urea)
N-(p-toluenesulphonyl)-N′-(3-p-toluenesulphonyloxyphenyl)urea)
N-(p-Toluenesulphonyl)-N′-(3-Phenylsulphonyloxyphenyl)
N-(p-Toluenesulphonyl)-N′-(2-p-Toluenesulphonyloxyphenyl)
N-(p-Toluenesulphonyl)-N′-(2-Phenylsulphonyloxyphenyl)
N-(p-Toluenesulphonyl)-N′-(4-Benzoyloxyphenyl)
N-(p-Toluenesulphonyl)-N′-(4-Phenylsulphonyloxyphenyl)
N-(p-Toluenesulphonyl)-N′-(4-Acetoxyphenyl)
N-(p-Toluenesulphonyl)-N′-(2-p-Toluenesulphonyloxy-5-ethylsulphonyl phenyl)
N-(o-Toluenesulphonyl)-N′-(3-p-Toluenesulphonyloxyphenyl)
N-(4-Chlorobenzenesulphonyl)-N′-(3-p-Toluenesulphonyloxyphenyl)
N-(p-Toluenesulphonyl)-N′-(4-p-Toluenesulphonyloxyphenyl)
N-(p-Toluenesulphonyl)-N′-(3-Butylsulphonyloxyphenyl)
N-(p-Toluenesulphonyl)-N′-(2-Methyl-4-p-toluenesulphonyloxyphenyl)
N-(p-Toluenesulphonyl)-N′-(5-methyl-3-p-toluenesulphonyloxy-2-pyrimidyl)
N-(p-Toluenesulphonyl)-N′-(5-p-Toluenesulphonyloxynapthyl)
N-(p-Toluenesulphonyl)-N′-(4-p-Tolyloxysulphonylphenyl)
N-(p-Toluenesulphonyl)-N′-(3-Octylsulphonyloxyphenyl)
N-(p-Toluenesulphonyl)-N′-(3-Hexadecylsulphonyloxyphenyl)
N-(Benzenesulphonyl)-N′-(4-Trirmethylacetamidophenyl)
N-(4-Chloro phenylsulphonyl)-N′-(2-(p-Toluenesulphonyloxy)phenyl)
N-(p-Toluenesulphonyl)-N′-(3-(N,N-di-p-Toluenesulphonyl)aminophenyl)
N-(Benzenesulphonyl)-N′-(2-(p-Toluenesulphonyloxy)phenyl)
N-(4Chloro phenylsulphonyl)-N′-(4-Acetamidosulphonylphenyl)
N-(p-Toluenesulphonyl)-N′-(3-(Diphenylphosphinyl)phenyl)
N-(p-Toluenesulphonyl)-N′-(4-Benzyloxyphenyl)
N-(p-Toluenesulphonyl)-N′-(3-Benzyloxyphenyl)
N-(p-Toluenesulphonyl)-N′-(3-Phenyloxyphenyl)
N-(Octylsulphonyl)-N′-(3-p-Toluene-sulphonyloxyphenyl)
N-(p-Toluenesulphonyl)-N′-(4-Phenylsulphonyloxyphenyl)
N-(Phenylsulphonyl )-N′-(3-(p-Toluenesulphonyloxy)phenyl)
N-(p-Toluenesulphonyl)-N′-(3-Trimethylacetoxyphenyl)
N-(4-Ghlorophenylsulphonyl)-N′-(4-(p-Toluenesulphonyloxy)phenyl)
N-(p-Toluenesulphonyl)-N′-(4-Acetophenyl)
N-(p-Toluenesulphonyl)-N′-(4-Acetamidosulphonyiphenyl)
N-(p-Toluenesulphonyl)-N′-(3-(Ethoxycarbonyloxy)phenyl)
N-(p-Toluenesulphonyl)-N′-(3-(Ethoxycarbamyl)phenyl)
N-(p-Toluenesulphonyl)-N′-(3-(2-napthyl sulphonyloxy)phenyl)
N-(p-Toluenesulphonyl)-N′-(4-Benzoylphenyl)
N-(p-Toluenesulphonyl)-N′-(3-(4-toluenesulphonylamino)phenyl)
N-(p-Toluenesulphonyl)-N′-(3-Acetaminophenyl), and
N-(4-Chloro phenylsulphonyl)-N′-(4-Trimethylacetamidophenyl),

EP-A-1116713 related to a new type of a developer, which can well be used for example with leuco dyes. It is characteristic of the developer that it consists of a urea urethane compound containing at least one urea group and at least one urethane group. According to the publication it is essential that the total number of the groups mentioned is between three and ten in the compound. Further, it is of course possible to use at the same time one or several of the compounds mentioned as the developer. The publication contains a very diversified description of the production of the compound mentioned from almost countless numbers of initial chemicals; therefore as far as the production and the detailed structure of the compound are concerned, the publication itself is cited here as reference.

As an exemplary way of improving the permanence of color, the publications discussed above disclose providing a special protecting layer on top of the heat-sensitive layer with which the influence of moisture, oils, greases and solvents on the permanence of the print image can be reduced to some extent. However, providing the protecting layer on top of the heat-sensitive layer involves extra work and thus increases significantly the production costs and naturally also the price of the paper. The main reason for this is that applying a second coating layer after the heat-sensitive layer has been produced presupposes the use of at least one additional coating unit. Further, also a protecting layer of this kind has been found to have its drawbacks. It has been found that both moisture and oils and corresponding substances quickly absorb from the edge of the paper sheet (e.g. a bar code slip, a cash receipt or a trip ticket) to the paper material itself and very quickly make the print image fade away.

Some chemicals, for example some epoxy compounds, have been found to prevent very efficiently the fading of the color but these substances have also been found to take effect rather slowly, whereby, if the print is fairly quickly subjected to the factor deteriorating it, the chemical in question has no time to act and the print image will disappear.

Performed studies have revealed that the various methods described above, which aim at improving the permanence of the print on heat-sensitive recording materials, do not reach the level of color permanence which the customers easily require. This is revealed by the tact that a large share of the heat-sensitive recording material used on the market is coated with a protecting layer, In other words, the customers are willing to pay even a remarkable extra price for a better color duration than conventional.

Although both a urea-type developer on the one hand and a chelate-type color former on the other hand improve in their own way the quality of the end product, both of these compounds have their weaknesses.

Firstly, a conventional leuco dye with a conventional developer, which combination as such is the most common in use, gives a good printing sensitivity but scarcely any permanence, at least when the print image is subjected to a detrimental factor. This is due to the fact that the color formation reaction of leuco dyes is reversible.

Secondly, a leuco dye with a urea-type developer gives a good sensitivity and improves the short-term permanence of the print image compared with the conventional method described above but, however, does not produce long term color permanence. It has been found out, for example, that in some special circumstances, such as in contact with plasticizers, the urea-type developer with a leuco dye loses readability very quickly.

Thirdly, a chelate system, as has been stated above, does not reach the color density level satisfying the customers although the chemicals required are remarkably more expensive than leuco dyes.

As the prior art indicates that leuco dyes produce as such a good print image even if for a short time, and as a chelate-type color forming system, despite its unpopularity on the market, gives permanence to the print image, the development work, the result of which the present invention is, was carried out with a combination of leuco dye and urea-based developer and a chelate-type color forming system.

The color forming system according to the present invention, which as stated uses a chelate-type color forming system with a leuco dye and a urea-type developer, both produces print images having a printing sensibility and color duration, which are remarkably better than with prior art combinations, whereby a print kept even in difficult conditions remains readable for a substantially longer time than conventional products, and at the same time having a very good contrast, particularly at the beginning. Compared with prior art thermal papers, one could speak about eternal duration. In normal conditions the product of the present invention is capable of even competition with recording materials coated with a protecting surface. It should be noted that prior art protection-coated paper loses its print images altogether if kept long enough in detrimental conditions. The product according to the present invention in turn permanently preserves a visually readable optical density of the print image.

The characteristic features of the present invention are disclosed more specifically in the appended patent claims.

The heat-sensitive recording material of the invention is described more in detail below with reference to the accompanying drawing figures of which

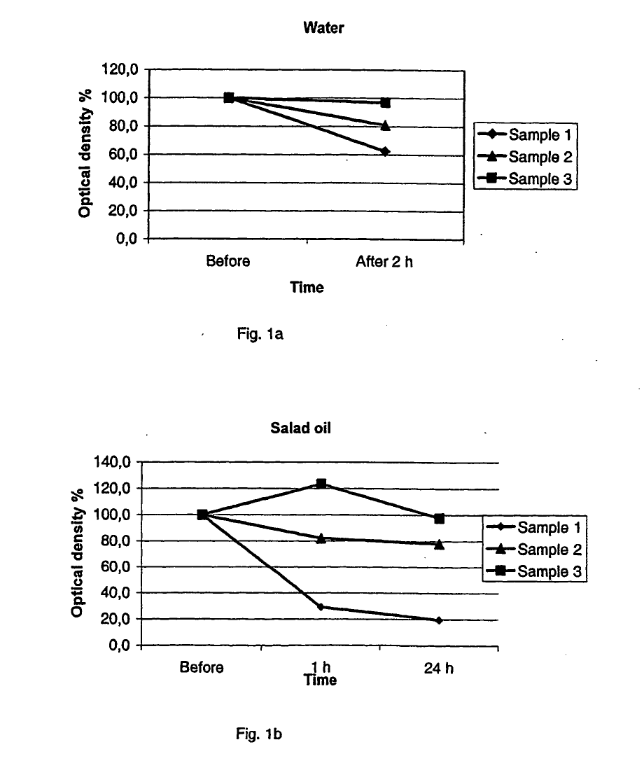

FIGS. 1a-1d illustrate the change in the density of the bar codes obtained with prior art color forming systems in various circumstances;

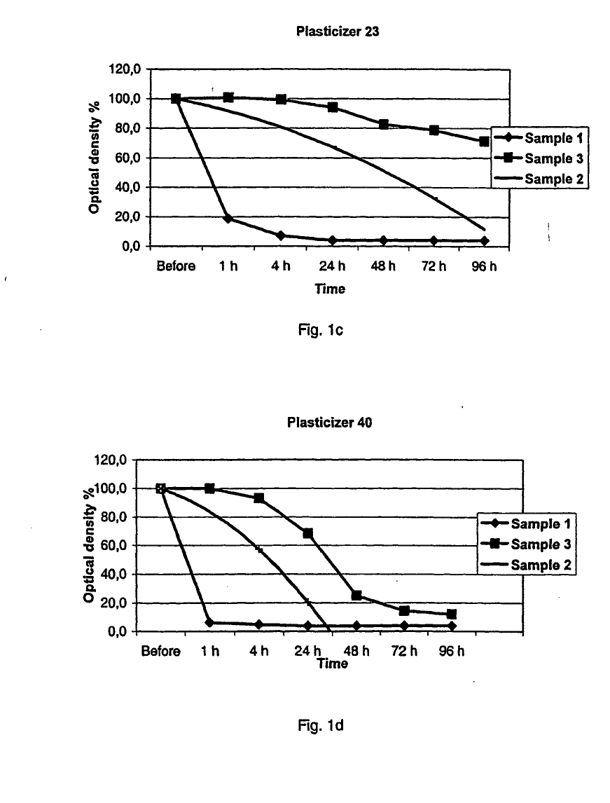

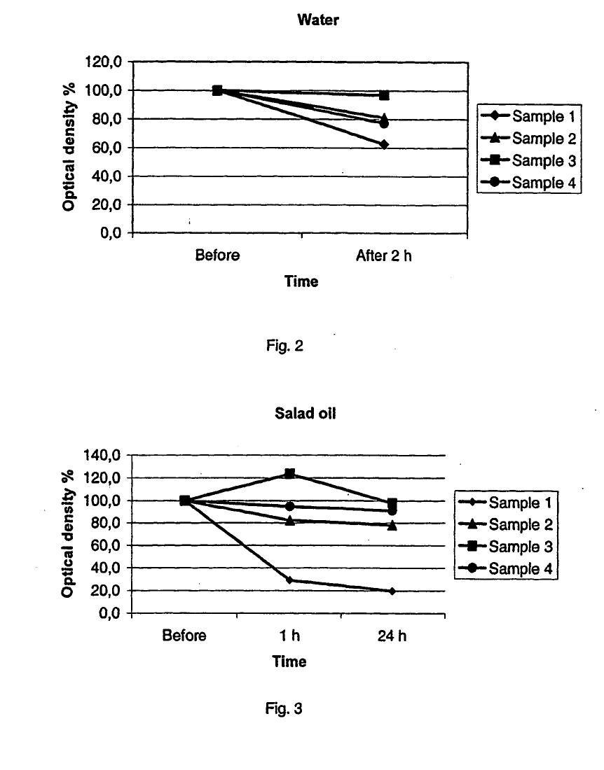

FIG. 2 illustrates the change in the density of a bar code obtained with a the color forming system according to a preferred embodiment of the present invention, as a function of time, when the print has been soaked in water;

FIG. 3 illustrates the change in the density of a bar code obtained with a the color forming system according to a preferred embodiment of the present invention, as a function of time, when the print has been treated with salad oil;

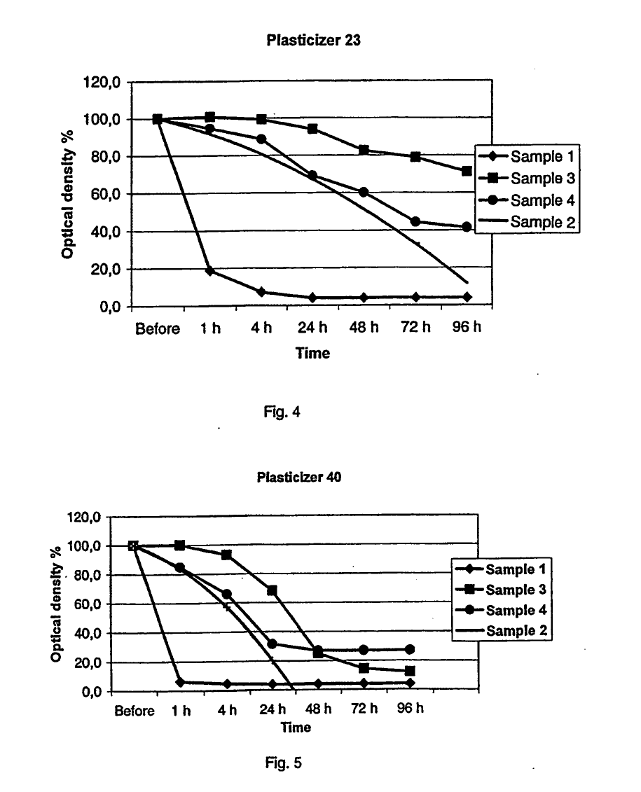

FIG. 4 illustrates the change in the density of a bar code obtained with the color forming system according to a preferred embodiment of the present invention, as a function of time, when the print has been brought at the temperature of 23° C. into contact with a surface treated with a plasticizer;

FIG. 5 illustrates the change in the density of a bar code obtained with the color forming system according to a preferred embodiment of present invention, as a function of time, when the print has been brought at the temperature of 40° C. into contact with a surface treated with a plasticizer;

The test we have performed are described below with reference to the accompanying drawing figures and the appended tables. At first the test apparatus is described. The thermal printer used was MarkpointMP104 produced by Markpoint, where R=800 Ω. The optic density was determined with a Macbeth meter RD-918 without a filter.

In the test situation illustrated by FIGS. 1a-1d, the bar codes were printed on prior art recording material using prior art color forming systems. In sample 1, the color former was a conventional leuco dye, S205, and the developer 4,4′-isopropylidenediphenol, commercial name bisphenol A, i.e. BPA. In sample 2, the color former was a leuco dye, S205, and the developer a urea-type product of CIBA Specialty Chemicals, known under commercial name PERGAFAST. In sample 3 in turn a recording material having a surface coating has been used for comparison, onto which a bar code has been printed using a conventional leuco dye, S205, and a conventional developer, NY-DS.

FIG. 1a illustrates the change in the density of the bar code in a test situation in which each of the bar code samples described above was immersed into water for two hours. After that, excess water was dried with blotting paper and the samples were allowed to dry completely before the final measurement. The density was determined both before the samples were immersed into water and after they had dried. It is easy to see from the figure, as well as from the appended table 1 that by far the best result is naturally obtained with the protection-coated recording material provided with protecting coating (sample 3), which has lost only a few percents of its density. Sample 1 has lost almost 40 percent of its density, sample 2 almost 30 percent and sample 3 about 20 percent.

TABLE 1

| | Sample 1 | | Sample 2 | | Sample 3 | |
|---|---|---|---|---|---|---|
| Water | O.D. | % | O.D. | % | O.D. | % |
| Initial | 1.28 | 100.0 | 1.23 | 100.0 | 1.31 | 100.0 |
| 2 h | 0.8 | 62.5 | 1.00 | 81.3 | 1.27 | 96.9 |

FIG. 1b illustrates the change in the density of the bar code in the test situation in which the bar code sample described above was wetted with salad oil by applying oil evenly on the sample with a swab. After the application, excess oil was removed with a blotting paper. The density was determined both before the oil was applied and after one hours and 24 hours from the application. Results in Table 2 indicate that the protection-coated recording material (sample 3) preserves the density of the bar code at a good level throughout the whole test. A bar code produced with conventional chemicals (sample 1) loses already in an hour more than two thirds of its density and a bar code produced with a urea-based developer (sample 2) almost 20 percent. After 24 hours only about 20 percent of the density of the sample 1 still remains, in sample 2 less than 80 percent and in sample 3 almost 98 percent.

TABLE 2

| | Sample 1 | | Sample 2 | | Sample 3 | |
|---|---|---|---|---|---|---|
| Salad oil | O.D. | % | O.D. | % | O.D. | % |
| Initial | 1.27 | 100.0 | 1.23 | 100.0 | 1.32 | 100.0 |
| 1 h | 0.37 | 29.1 | 1.01 | 82.1 | 1.63 | 123.5 |
| 24 h | 0.25 | 19.7 | 0.96 | 78.0 | 1.29 | 97.7 |

FIGS. 1c and 1d illustrate the change in the density of the bar code in the test situation in which each bar code sample described above was arranged into contact with a material treated with a plasticizer. This was done by placing each sample between two plastic films. The samples were kept either in an air-conditioned space at 23° C. or in an oven at 40° C. for different periods of time. The test situation was continued even up to 96 hours (four days and nights). FIG. 1c and table 3 illustrate the change in the density at the temperature of 23° C. and FIG. 1 and table 4 at the temperature of 40° C. The results indicate that a bar code produced using conventional chemicals (sample 1) lost already in an hour more than 80 percent of its density, at the highest temperature even almost 95 percent of its density. The clearest influence of the temperature is to be seen in sample 2, i.e. with an urea-based developer, with which the density decreases evenly at the temperature of 23° C. and it is for example after three days and nights (72 h) only of the order of 30 percent of the original. However, at the temperature of 40° C. the density collapses rapidly and is already after about one day and night of the order of 20 percent. The color seems to disappear altogether during the second day and night. It should be noted, however, that only the initial density and two density degrees were measured from sample 2 during the test. The trend curves illustrated in FIGS. 1c and 1d have been drawn based on the results of these measurements. There is no reason to doubt the results obtained as both the cases indicate exactly the same direction, the raise in the temperature only accelerates the fading of the color. The second clearest influence of the temperature change is to be seen with the protection-coated recording material with which the density remains throughout the whole test period at the room temperature (23° C.) at more than 70 percent but at the temperature of 40° C. collapses during the second day and night to a level below the density of the sample using a chelate-based developer. After the studied period had ended there were no differences to be seen between samples 1 and 3, at least as far as readability is concerned. In other words, both samples were not readable.

TABLE 3

| Plasticizer | Sample 1 | | Sample 2 | | Sample 3 | |
|---|---|---|---|---|---|---|
| 23° C. | O.D. | % | O.D. | % | O.D. | % |
| Initial | 1.27 | 100.0 | 1.28 | 100.0 | 1.32 | 100.0 |
| 1 h | 0.24 | 18.9 | | | 1.33 | 100.8 |
| 4 h | 0.09 | 7.1 | | | 1.31 | 99.2 |
| 24 h | 0.05 | 3.9 | 0.86 | 67.2 | 1.24 | 93.9 |
| 48 h | 0.05 | 3.9 | | | 1.09 | 82.6 |
| 72 h | 0.05 | 3.9 | 0.42 | 32.8 | 1.04 | 78.8 |
| 96 h | 0.05 | 3.9 | | | 0.94 | 71.2 |

TABLE 4

| Plasticizer | Sample 1 | | Sample 2 | | Sample 3 | |
|---|---|---|---|---|---|---|
| 40° C. | O.D. | % | O.D. | % | O.D. | % |
| Initial | 1.27 | 100.0 | 1.26 | 100.0 | 1.32 | 100.0 |
| 1 h | 0.08 | 6.3 | | | 1.32 | 100.0 |
| 4 h | 0.06 | 4.7 | 0.72 | 57.1 | 1.23 | 93.2 |
| 24 h | 0.05 | 3.9 | 0.26 | 20.6 | 0.9 | 68.2 |
| 48 h | 0.05 | 3.9 | | | 0.33 | 25.0 |
| 72 h | 0.05 | 3.9 | | | 0.19 | 14.4 |
| 96 h | 0.05 | 3.9 | | | 0.16 | 12.1 |

Generally speaking, it seems that no tested prior art chemical or chemical compound produces a printing image ideal in all respects. In the figures presented the axis x illustrating time has been placed to start from the reading 27.5% on the axis y illustrating optical density. This reading represents in a large number of print images the level of density, which is still readable with bare eyes. In other words, the cash receipt is readable but the bar code is not decodable (has not been automatically decodable for a long time).

When checking the readability of the print image it can be discovered that wetting of the print image does not with any color forming system cause any danger at least within the test period of two hours. Salad oil on the other hand impaired readability already in one hour in samples printed with leuco dyes and conventional developers. The same happened with a plasticizer, Based on this information, the most conventional leuco dyes and the developers used with them would be usable only in the easiest applications. Subjection to a plasticizer at 23° C. destroyed readability of a print using a urea-based developer in about three days and night, and at 40° C. already in less than 24 hours. A remarkable finding is also that a subjection to a plasticizer at 40° C. destroyed readability also of a protection-coated print produced with a conventional leuco dye and the developer suitable for use with it.

The following is a description of the tests we have performed in which the color was produced by using both a conventional leuco dye and a urea-type developer marketed by CIBA SPECIALTY CHEMICALS under the name PERGAFAST, which is suitable for the color, and a chelate color forming system. The chemical in the chelate color forming system was iron zinc behenate. The test arrangements were the same as in the test of the prior art color forming systems described above.

FIG. 2 illustrates how sample 4 according to the invention, in which a combination of a leuco dye, a urea-type developer suitable for leuco dye and marketed under the name PERGAFAST, and a chelate-type color forming system was used, behaved in the test performed with water and described in connection with FIG. 1a, compared with prior art samples 1-3. The following table 5 indicates how much the optical density of the test print changed in the test. It should be noted that the density of sample 4 remained clearly better than that of the prior art prints, with the exception of the protection-coated print.

TABLE 5

| Water | O.D. | % |
|---|---|---|
| Initial | 1.32 | 100.0 |
| 2 h | 1.02 | 77.3 |

FIG. 3 illustrates how sample 4 according to the invention behaved in the test with salad oil described above in connection with FIG. 1b, compared with prior art samples 1-3. Both table 6 and FIG. 3 indicate that a print according to the invention preserves an optical density of over 90 percent through out the whole test period, which must be considered a surprisingly good achievement compared with the fact that the corresponding percentage of a prior art print which has not been coated with a protection layer, remains at a level under about 50 percent or even clearly below that with the exception of sample 2 which is a print produced using a urea-type developer. Only the print having a protecting surface layer preserves its density better but only a little better than the print according to the present invention.

TABLE 6

| Salad oil | O.D. | % |
|---|---|---|
| Initial | 1.33 | 100.0 |
| 1 h | 1.26 | 94.7 |
| 24 h | 1.21 | 91.0 |

FIG. 4 illustrates how a recording material according to the present invention behaves in the plasticizer test at the temperature of 23° C. described in connection with FIG. 1c. Table 7 presents the test results. The results in both FIG. 4 and tables 3 and 7 indicate that the sample 4 according to the invention preserves its readability (optical density) clearly better throughout the test period than the comparison material having no protecting surface layer. The material having a protecting surface layer (sample 3) has a somewhat better readability than the material according to the present invention. As far as readability with bare eyes is concerned, the sample according to the present invention remains readable throughout the whole test period.

TABLE 7

| Plasticizer 23° C. | O.D. | % |
|---|---|---|
| Initial | 1.33 | 100.0 |
| 1 h | 1.26 | 94.7 |
| 4 h | 1.18 | 88.7 |
| 24 h | 0.92 | 69.2 |
| 48 h | 0.8 | 60.2 |
| 72 h | 0.59 | 44.4 |
| 96 h | 0.55 | 41.4 |

FIG. 5 illustrates how a material according to the invention behaves in the more difficult plasticizer test at the temperature of 40° C., which has been described more in connection with FIG. 1d. The results in both FIG. 5 and tables 4 and 8 indicate that the sample 4 according to the inventions preserves its density clearly better than any of the rest of the samples including the sample having a protecting surface layer. The samples 1 and 2 representing prior art do not preserve their density as well as the print according to the invention. They both lose a very high percentage of their density at once at the beginning of the test period. The print having a protecting surface layer preserved good quality for about 24 hours but after that its density is remarkably weaker than that of the print according to the present invention. The sample 4 according to the present invention remains readable with bare eyes throughout the whole test period (4 days and night), unlike the sample coated with a protecting layer (sample 3), which loses its readability already in about two days and nights. The curves in both FIG. 4 and FIG. 5 illustrating sample 4 show that a print produced with the chemicals according to the present invention seems to remain unchanged also in the future, as in both cases the curve has reached substantially the horizontal direction.

The results presented above give grounds to the conclusion that the heat-sensitive recording material according to the present invention does not react to any disturbance factor radically but its degree of density decreases as a whole more evenly that the density of prior art products.

In addition to the conventional developers and color formers mentioned in the prior art publications and in the examples discussed above, it is possible to use in connection with the compound of leuco dye and urea-type developers and chelate color forming systems according to the invention for example the developers, color formers and sensitizers mentioned in the following lists in producing bar codes and other print images on thermal papers and corresponding heat-sensitive recording materials. A sensitizer is a chemical which decreases the melting point of the coating material.

Thus, in addition to the developers mentioned above, for example the following can be used:
1,3-di[2-(2,4-dihydroxyphenyl)-2propyl]benzene,
1,3-di[2-(2-hydroxy-5-methylphenyl)-2propyl]benzene,
1,3-di[2-(4-hydroxy-3-alkylphenyl)-2propyl]benzene,
1,3-di[2-(4-hydroxyphenyl)-2propyl]benzene,
1,3-dihydroxy-6(α,α-dimethylbenzyl)-benzene,
2,4-dihydroxybenzophenone,
2-hydroxy-5-t-aminophenyl-4′-hydroxyphenylsulfone,
2-hydroxy-5-t-butylphenyl-2′-methyl-4′-hydroxyphenylsulfone,
2-hydroxy-5-t-butylphenyl-3′-chloro-4′-hydroxyphenylsulfone,
2-hydroxy-5-t-butylphenyl-3′-ispropyl-4′-hydroxyphenylsulfone,
2-hydroxy-5-t-butylphenyl-3′-methyl-4′-hydroxyphenylsulfone,
2-hydroxy-5-t-butylphenyl-4′-hydroxyphenylsulfone,
2-hydroxy-5-t-isopropylphenyl-4′-hydroxyphenylsulfone,
2-hydroxy-5-t-octylphenyl-4′-hydroxyphenylsulfone,
3,3′5,5′-tetrabromo-4,4′-sulfonyldiphenol,
3,3′-diamino-4,4′-sulfonyldiphenol,
3,3′-dichloro-4,4′-sulfonyldiphenol,
3-chloro-4-hydroxyphenyl-3′-isopropyl-4′-hydroxyphenylsulfone,
4,2′-sulfonyldiphenol,
4,4′-cyclohexylidenediphenol,
4,4′-isopropylidenediphenol (also known under commercial name
bisphenol A or BPA),
4,4′-sulfonyldiphenol,
4-hydroxy-4′-n-butyloxydiphenylsulfone,
4-hydroxyacetophenone,
4-hydroxybenzoyloxy α-naphthyl benzoate,
4-hydroxybenzoyloxy β-naphthyl benzoate,
4-hydroxybenzoyloxy β-phenethyl benzoate,
4-hydroxybenzoyloxybenzyl benzoate,
4-hydroxybenzoyloxybutyl benzoate,
4-hydroxybenzoyloxycyclohexyl benzoate,
4-hydroxybenzoyloxyethyl benzoate,
4-hydroxybenzoyloxyhexyl benzoate,
4-hydroxybenzoyloxyisopropyl benzoate,
4-hydroxybenzoyloxymethyl benzoate,
4-hydroxybenzoyloxynonyl benzoate,
4-hydroxybenzoyloxyoctyl benzoate,
4-hydroxybenzoyloxypropyl benzoate,
4-hydroxybenzoyloxysec-butyl benzoate,
4-hydroxybenzoyloxytert-butyl benzoate,
4-hydroxybenzyl benzoate,
4-hydroxybutyl benzoate,
4-hydroxydibenzyl phthalate,
4-hydroxydihexyl phthalate,
4-hydroxydiisopropyl phtalate,
4-hydroxydimethyl phthalate,
4-hydroxyethyl benzoate,
4-hydroxyisobutyl benzoate,
4-hydroxyisopropyl benzoate,
4-hydroxymethylbenzyl benzoate,
4-hydroxyphenyl-1′-naphtalenesulfonate,
4-hydroxyphenyl-2′-ethyl-4′-hydroxyphenylsulfone,
4-hydroxyphenyl-2′-isopropyl-4′-hydroxyphenylsulfone,
4-hydroxyphenyl-2′-naphtalenesulfonate,
4-hydroxyphenyl-3′-isopropyl-4′-hydroxyphenylsulfone,
4-hydroxyphenyl-3′-sec-butyl-4′-hydroxyphenylsulfone,
4-hydroxyphenylbenzenesulfonate,
4-hydroxyphenylmethylenesulfonate,
4-hydroxyphenyl-p-chlorobenzenesulfonate,
4-hydroxyphenyl-p-isopropoxybenzenesulfonate,
4-hydroxyphenyl-p-tert-butylbenzenesulfonate,
4-hydroxyphenyl-p-tolylsulfonate,
4-hydroxypropyl benzoate,
benzyl-4-hydroxyphenylacetate,
bis-(2,3,4-trihydroxyphenyl)sulfide,
bis-(2,3-dimethyl-4-hydroxyphenyl)sulfone,
bis-(2,4,5-trihydroxyphenyl)sulfide,
bis-(2,5-dimethyl-4-hydroxyphenyl)sulfone,
bis-(2-ethyl-4-hydroxyphenyl)sulfone,
bis-(2-isopropyl-4-hydroxyphenyl)sulfone,
bis-(3-chloro-4-hydroxyphenyl)sulfone,
bis-(3-ethyl4-hydroxyphenyl)sulfone,
bis-(3-methoxy-4-hydroxyphenyl)sulfone,
bis-(3-methyl-4-hydroxyphenyl)sulfone,
bis-(3-propyl-4-hydroxyphenyl)sulfone,
bis-(4,5-dihydroxy-2-tert-butylphenyl)sulfide,
bis-(4-hydroxy-2,3-dimethylphenyl)sulfide,
bis-(4-hydroxy-2,3,6-trimethylphenyl)sulfide,
bis-(4-hydroxy-2,5-diisopropylphenyl)sulfide,
bis-(4-hydroxy-2,5-dimethylphenyl)sulfide,
bis-(4-hydroxy-2,5-diphenylphenyl)sulfide,
bis-(4-hydroxy-2-cyclohexyl-5-methylphenyl)sulfide,
bis-(4-hydroxy-2-methyl-5ethylphenyl)sulfide,
bis-(4-hydroxy-2-methyl-5-isopropylphenyl)sulfide,
bis-(4-hydroxy-2-tert-octyl-5methylphenyl)sulfide,
bis-(4-hydroxy-3-tert-butyl-6-methylphenyl)sulfide,
bis-(phenyl3-1,butyl-4-hydroxy-6-methylphenyl)sulfone,
monobenzyl phthalate,
monocyclohexyl phthalate,
monoethoxybenzyl phthalate,
monoethylphenyl phthalate,
monohalogenbenzyl phthalate,
monomethylphenyl phthalate,
monophenyl phthalate,
monopropylbenzyl phthalate,
novolac type phenolic resin,
p,p′-(1-methyl-n-hexylidene)diphenol,
p-benzylphonol,
p-phenylphenol,
p-tert-butylphenol,
4,4′-(oxy-bis-(ethyleneoxy-p-phenylenesulfony))diphenol mixture,
bis-(3-allyl-4-hydroxyphenyl)sulfone, and
phenyl type oligomer.

In addition to the color formers mentioned above, also for example the following can be used as color formers in connection with the present invention:
3-(dibutylamino)-7-(2-chlorophenylamino)fluoran,
3(diethylamino)-6-methyl-7-(2,4-dimethylphenylamino)fluoran,
3-(diethylamino)-6-methyl-7-(3-methylphenylamino)fluoran,
3-(diethylamino)-7-(3-trifluoromethylphenylamino)fluoran,
3-(dipentylamino)-6-methyl-7-anilinofluoran,
3-(N-ethyl-N-isobutylamino)-6-methyl-7-anilinofluoran,
3-(N-ethyl-N-isopentylamino)-7-(2-chlorophenylamino)fluoran,
3-(N-ethyl-N-p-tolylamino)-6-methyl-7-anilinofluoran,
3-(N-methyl-N-cyclohexylamino)-6-methyl-7-anilinofluoran,
3-(N-methyl-N-propylamino)-6-methyl-7-anilinofluoran,
3-(N-tetrahydrofurfuryl-N-ethylamino)-6-methyl-7-anilinofluoran, and
3-[N-ethyl N-(3-ethoxypropyl)amino]-6-methyl-7-anilinofluoran.

For example the following can be used as sensitizers:
1-(4-methoxyphenoxy)-2-(2-methylphenoxy)ethane,
1,2-bis(phenoxymethyl)benzene,
1,2-di(3-methylphenoxy)ethane,
1,2-di(4-chlorophenoxy)ethane,
1,2-di(4-methoxyphenoxy)ethane,
1,2-di(4-methylphenoxy)ethane,
1,2-diphenoxyethane,
1,4-di(phenylthio)buthane,
1-hydroxy-2-phenylnaphthoate,
1-isopropylphenyl-2-phenylethane,
2-naphtylbenzylether,
4-(4-tolyloxy)biphenyl,
4-biphenyl-p-tolyether,
behenic acid amidemethylene-bis-stearic acis amide,
di(p-methoxyphenoxyethyl)ether,
di-(β-biphenylethoxy)benzene,
dibenzyl terephthalate,
dibenzyloxalate,
dimethyl terephthalate,
dioctyl terepthalate,
di-p-chlorobenzyloxalate,
di-p-methylbenzyloxalate,
di-p-tolylcarbonate,
ethylene-bis-stearic acid amide,
methoxycarbonyl-N-benzamidestearate,
methylene-bis-stearic acid amide,
methyloamide,
m-terphenyl,
N-acetoacetyl-p-toluidine,
N-benzoylstearic acid amide,
N-eicosenoic acid amide,
N-methylostearic acid amide,
o-toluenesulfonamide,
p-acetophenetidide,
p-actotoluidide,
palmitic acid amide,
p-benzylbiphenyl,
p-benzyloxybenzylbenzoate,
p-di(vinyloxyethoxy)benzene,
phenyl-α-naphtylcarbonate,
p-methylthiophenylbenzylether,
p-toluenesulfonamide, ja
stearic acid amide, ja
1,1′-sulphonyl bis-benzene.

In the production of recording material, color former, developer and sensitizer are dispersed into liquid, usually water, together with a suitable binder.

For example the following are used as binders:
amide-modified polyvinylalcohol,
carpoxymethylcellulose,
carpoxy-modified polyvinyl alcohol,
casein,
gelatin,
hydroxyethylcellulose,
methylcellulose,
petroleum resins,
polyacrylamide,
polyacrylic acid,
polyacrylic acid esters,
polyamide resins,
polyvinyl acetate,
polyvinyl alcohol,
silicone-modified polyvinyl alcohol,
starch,
styrene-butadiene copolymer,
styrene-maleic acid copolymer,
sulfonic acid-modified polyvinyl alcohol, ja
terpene resins.

Further, fillers are used in paper production in manners known per se; fillers are for example:
aluminium hydroxide,
calcined caolin,
calcium carbonate,
diatomaceous earth,
kaolin,
nylon powder,
silica,
styrene microballs,
talc,
titanium oxide, ja
ureaformaline resin.

Further, “lubricants” are used in paper production, which are for example:
polyethylene wax,
stearic acid ester wax, and
zinc stearate.

As can be seen from what has been presented above, a heat-sensitive recording material has been developed which is better in all respects (at least in all tested respects) than directly comparable prior art recording materials. The recording material according to the present invention even endures certain strain factors remarkably better than a recording material provided with a protecting surface which until now has been considered to be the most advanced technology in the field and meeting best the requirements of the customers. Finally, it should be kept in mind that only a few most preferred embodiments of the invention have been described above without any intention of limiting the scope of protection of the invention from what has been defined in the appended patent claims. Thus, it is clear that in addition to the chemicals mentioned in the examples above, also other corresponding chemicals or chemical compounds with corresponding properties are included in the scope of protection of the invention.

1. A heat-sensitive recording material containing a base material and at least one coating layer, in which layer the chemicals of at least two color forming systems are located, characterized in that at least one of the color forming systems used is a chelate-type color forming system and the other one at least one leuco dye with at least one urea-based developer.

2. A recording material as claimed in claim 1, characterized in that said urea-type developer is at least one of the following:
N-(p-toluenesulfonyl)-N′-phenylurea,
N-(p-toluenesulfonyl)-N′-(p-methoxyphenyl)urea,
N-(p-toluenesulfonyl)-N′-(o-tolyl)urea,
N-(p-toluenesulfonyl)-N′-(m-tolyl)urea,
N-(p-toluenesulfonyl)-N′-(p-tolyl)urea,
N-(p-toluenesulfonyl)-N′-(p-n-butylphenyl)urea,
N-(p-toluenesulfonyl)-N′,N′-diphenylurea,
N-(p-toluenesulfonyl)-N′-(o-chlorophenyl)urea,
N-(p-toluenesulfonyl)-N′-(m-chlorophenyl)urea,
N-(p-toluenesulfonyl)-N′-(2,4-dichlorophenyl)urea,
N-(p-toluenesulfonyl)-N′-methyl-N′-phenylurea,
N-(p-toluenesulfonyl)-N′-benzylurea,
N-(p-toluenesulfonyl)-N′-(1-naphthyl)urea,
N-(p-toluenesulfonyl)-N′-(1-(2-methylnaphthyl))urea,
N-(benzenesulfonyl)-N′-phenylurea,
N-(p-chlorobenzenesulfonyl)-N′-phenylurea,
N-(o-toluenesulfonyl)-N′-phenylurea,
N-(p-toluenesulfonyl)-N′-methylurea,
N-(p-toluenesulfonyl)-N′-ethylurea,
N-(p-toluenesulfonyl)-N′-(2-phenoxyethyl)urea,
N,N′-bis(p-toluenesulfonyl)urea,
N-(p-toluenesulfonyl)-N′-phenylthiourea,
N-(p-toluenesulfonyl)-N′-(o-diphenyl)urea,
N-(p-toluenesulfonyl)-N′-(p-ethoxycarbonylphenyl)urea N-(p-toluenesulphonyl)-N′-(4-trimethylacetophenyl)urea,
N-(benzenesulphonyl)-N′-(3-p-toluenesulphonyloxyphenyl)urea,
N-(p-toluenesulphonyl)-N′-(2-n-butylaminosulphonylpheryl)urea,
N-(P-toluenesulphonyl)-N′-(4-trimethylacetophenyl)urea,
N-(p-toluenesulphonyl)-N′-(3-p-toluenesulphonyloxyphenyl)urea,
N-(p-toluenesulphonyl)-N′-(3-Phenylsulphonyoxyphenyl)urea,
N-(p-Toluenesulphonyl)-N′-(2-p-Toluenesulphonyloxyphenyl)urea,
N-(p-Toluenesulphonyl)-N′-(2-Phenylsulphonyloxyphenyl)urea,
N-(p-Toluenesulphonyl)-N′-(4-Benzoyloxyphenyl)urea,
N-(p-Toluenesulphonyl)-N′-(4-Phenylsulphonyloxyphenyl)urea,
N-(p-Toluenesulphonyl)-N′-(4-Acetoxyphenyl)urea,
N-(p-Toluenesulphonyl)-N′-(2-p-Toluenesulphonyloxy-5-ethylsulphonyl phenyl)urea,
N-(o-Toluenesulphonyl)-N′-(3-p-Toluenesulphonyloxyphenyl)urea,
N-(4-Chlorobenzenesulphonyl)-N′-(3-p-Toluenesulphonyloxyphenyl)urea,
N-(p-Toluenesulphonyt)-N′-(4-p-Toluenesulphonyloxyphenyl)urea,
N-(p-Toluenesulphonyl)-N′-(3-Butylsulphonyloxyphenyl)urea,
N-(p-Toluenesulphonyl)-N′-(2-Methyl-4-p-toluenesulphonyloxyphenyl)urea,
N-(p-Toluenesulphonyl)-N′-(5-methyl-3-p-toluenesulphonyloxy-2-pyrimidyl)urea,
N-(p-Toluenesulphonyl)-N′-(5-p-Toluenesulphonyloxynapthyl)urea,
N-(p-Toluenesulphonyl)-N′-(4-p-Tolyloxysulphonylphenyl)urea,
N-(p-Toluenesulphonyl)-N′-(3-Octylsulphonyloxyphenyl)urea,
N-(p-Toluenesulphonyl)-N′-(3-Hexadecylsulphonyloxyphenyl)urea,
N-(Benzenesulphonyl)-N′-(4-Trimethylacetamidophenyl)urea,
N-(4-Chloro phenylsulphonyl)-N′-(2-(p-Toluenesulphonyloxy)phenyl)urea,
N-(p-Toluenesulphonyl)-N′-(3-(N,N-di-p-Toluenesulphonyl)aminophenyl)urea,
N-(Benzenesulphonyl)-N′-(2-(p-Toluenesulphonyloxy)phenyl)urea,
N-(4-Chloro phenylsulphonyl)-N′-(4-Acetamidosulphonylphenyl)urea,
N-(p-Toluenesulphonyl)-N′-(3-(Diphenylphosphinyl)phenyl)urea,
N-(p-Toluenesulphonyl)-N′-(4-Benzyloxyphenyl)urea,
N-(p-Toluenesulphonyl)-N′-(3-Benzyloxyphenyl)urea,
N-(p-Toluenesulphonyl)-N′-(3-Phenyloxyphenyl)urea,
N-(Octylsulphonyl)-N′-(3-p-Toluene-sulphonyloxyphenyl)urea,
N-(p-Toluenesulphonyl)-N′-(4-Phenylsulphonyloxyphenyl)urea,
N-(Phenylsulphonyl )-N′-(3-(p-Toluenesulphonyloxy)phenyl)urea,
N-(p-Toluenesulphonyl)-N′-(3-Trlmethylacetoxyphenyl)urea,
N-(4-GhloroPhenylsulphonyl)-N′-(4-(p-Toluenesulphonyloxy)phenyl)urea,
N-(p-Toluenesulphonyl)-N′-(4-Acetophenyl)urea,
N-(p-Toluenesulphonyl)-N′-(4-Acetamidosulphonylphenyl)urea,
N-(p-Toluenesulphonyl)-N′-(3(Ethoxycarbonyloxy)phenyl)urea,
N-(p-Toluenesulphonyl)-N′-(3-(Ethoxycarbamyl)phenyl)urea,
N-(p-Toluenesulphonyl)-N′-(3-(2-napthyl sulphonyloxy)phenyl)urea,
N-(p-Toluenesulphonyl)-N′-(4-Benzoylphenyl)urea,
N-(p-Toluenesulphonyl)-N′-(3-(4-toluenesulphonylamino)phenyl)urea,
N-(p-Toluenesulphonyl)-N′-(3-Acetaminophenyl)urea, and
N-(4-Chloro phenylsulphonyl)-N′-(4Trimethylacetamidophenyl)urea.

3. A recording material as claimed in claim 1, characterized in that a part of the chelate-type color forming system is at least one of the following double salts:
Iron zinc stearate,
Iron zinc montanate,
Acid wax iron zinc,
Iron zinc behenate,
Iron calcium behenate,
Iron aluminum behenate,
Iron magnesium behenate,
Silver calcium behenate,
Tin aluminum behenate,
Silver magnesium behenate, and
Calcium aluminum behenate.

4. A recording material as claimed in claim 1, characterized in that the urea-type developer is a compound of at feast two different urea-type developers.

5. A recording material as claimed in claim 1, characterized in that the urea-type developer is a compound of at least two urea-type developers mentioned.

6. A recording material as claimed in claim 1, characterized in that the chelate-type color forming system is a combination of at least two different chelate-type color forming systems.

7. A recording material as claimed in claim 1, characterized in that said one part of the chelate-type color forming system is a compound of at least two double salts mentioned.

8. A recording material as claimed in claim 1, characterized in that said urea-type developer is at least one urea-urethane compound containing at least one urea group and at least one urethane group.

9. A recording material as claimed in claim 1, characterized in that the number of said urea groups and urethane groups in the compound is between three and ten.
